(19) United States
(12) Patent Application Publication
(10) Pub. No.: US 2011/0128194 A1
(43) Pub. Date: Jun. 2, 2011

(54) FOLDABLE PORTABLE TERMINAL AND PORTABLE TERMINAL

(75) Inventors: Takeshi Sekine, Kanagawa (JP); Shingo Kume, Kanagawa (JP)

(73) Assignee: PANASONIC CORPORATION, Osaka (JP)

(21) Appl. No.: 12/999,549

(22) PCT Filed: Feb. 2, 2009
(86) PCT No.: PCT/JP2009/000391

§ 371 Date: Dec. 16, 2010

(30) Foreign Application Priority Data
Jun. 20, 2008 (JP) 2008-162274

(51) Int. Cl. H01Q 1/24

(52) U.S. Cl. 343/702

(57) ABSTRACT

A foldable portable terminal and a portable terminal that provide reliable waterproof are provided. A foldable portable terminal 10 has the followings on a hinge-side end 23A of an upper housing 14 in its longitudinal direction; namely, a first connector 41 connected to a conductive part 28A of an upper printed board 28; a plate conductive member 42 that is connected to the first connector and in which a first protuberance 53 is placed in a hinge case 31; a second connector 44 that is elastically connected to the plate member in the hinge case and that is connected to a hinge 32 by means of a first contact part 57, thereby feeding electric power; and a waterproof member 45 that comes into close contact with the plate member, thereby rendering the hinge case waterproof with respect to the upper housing 14.

### TECHNICAL FIELD

The present invention relates to a foldable portable terminal and a portable terminal.

### BACKGROUND ART

In relation to a waterproof foldable portable terminal adopting an antenna, placing the antenna in a waterproof area is idealistic (see; for instance, Patent Document 1).

However, in view of the performance and configuration of the antenna, it may also be a case where placing the antenna in a non-waterproof area, such as in a neighborhood of a surface of a housing or in a hinge, is desirable.

For instance, when a hinge is provided as a portion of the antenna, to thus configure a housing dipole antenna, electric power is fed to the hinge, and a frame of the housing or a ground pattern of a printed board is configured to act as an antenna (see; for instance, Patent Document 2).

Since the hinge itself is made conductive, the hinge can be used, in place of a power feed line, as a power feeding path. Because a process for routing the power feed line in the hinge can be obviated, the number of assembly steps can be curtailed. Moreover, in a portable radio having a power feed line, when the power feed line becomes deformed in the hinge, which in turn deteriorates antenna performance. However, since the portable radio of the invention can, in principle, prevent occurrence of deterioration of antenna performance, high antenna performance can stably be assured.
Patent Document 1; JP-A-20007-53718
Patent Document 2: JP-B-3596774

### DISCLOSURE OF INVENTION

Problem that Invention is to Solve

However, in connection with the configuration, when the portable terminal is made waterproof, the hinge is not a waterproof area; hence, there arises a necessity for securing waterproof so as to prevent intrusion of water into the housings.

The present invention has been conceived to fulfill the necessity and aims at providing a foldable portable terminal and a portable terminal that provide reliable waterproof even when a housing dipole antenna is configured.

### Means for Solving the Problem

A foldable portable terminal is configured by comprising: a waterproof first housing; a second housing; and a non-waterproof joint part that joins the first housing to the second housing, wherein the joint part has a conductive hinge and a non-waterproof hinge case which covers the hinge, and the foldable portable terminal comprises: a first connector which is provided on a hinge-side end of the first housing in its longitudinal direction and which is connected to a conductive part of a printed board; a plate conductive member which is connected to the first connector and a part of which is placed in the hinge case; a second connector which is elastically connected to the plate member in the hinge case and which is connected at its another end to the hinge to feed electric power; and a waterproof member that comes into close contact with the plate member and that makes the hinge case waterproof with respect to the first housing.

The first connector is provided on the hinge-side end of the first housing in its longitudinal direction and connected to the conductive part of the printed board. The plate member is connected to the first connector. A part of the plate member is placed in the hinge case, and has a conductivity.

The second connector is elastically connected to the plate member in the hinge case and connected at its another end to the hinge to feed electric power.

The waterproof member comes into close contact with the plate member and that makes the hinge case waterproof with respect to the first housing.

A housing dipole antenna is made up of the plate member, the hinge, and the conductive part of the printed board, etc.

Even when the housing dipole antenna is established, reliable waterproof can thereby be obtained.

In the present invention, a protuberance is formed in the plate member, and the protuberance is placed in the hinge case.

As a result of the protuberance being formed on the plate member, and the protuberance being placed in the hinge case, the length of the housing in its longitudinal direction can be reduced while an antenna path length is assured, so that the housing can be miniaturized.

In the present invention, the plate member is a metallic plate.

As a result of the plate member being realized by means of a metallic plate, conductivity of the plate member is easily achieved.

In the present invention, the plate member is a flexible board.

As a result of the plate member being realized by means of a flexible board, a degree of design flexibility can be enhanced.

In the present invention, the first connector or the second connector is a leaf spring.

As a result of the first connector or the second connector being realized by a leaf spring, the connector can be obtained by means of a simple configuration.

In the present invention, the waterproof member is a double-sided adhesive tape and bonded to at least an area of the plate member that surrounds a contact point to be brought into contact with the first connector.

The waterproof member is realized by a double-sided adhesive tape, and the double-sided adhesive tape is bonded to at least an area of the plate member that surrounds a contact point to be brought into contact with the first connector.

As a result of a double-sided adhesive tape being used as the waterproof member, the contact point to be brought into contact with the first connector can be made waterproof at low cost, and the assembly of the portable terminal can be made easier.

In the present invention, the first housing has a display, and the plate member is interposed between the display and the hinge.

In the present invention, the plate member is interposed between the display and the hinge. A portion of the metallic plate member is caused to protrude toward the hinge. Hence, when the plate member makes up a portion of for instance, an antenna, the length of the first housing in its longitudinal direction can be shortened while the antenna path length is assured. Thus, the foldable portable terminal can thereby be miniaturized.

In the present invention, the conductive part of the printed board of the first housing, the plate member, the hinge, and the conductive part of the printed board placed in the second housing operate as an antenna.

In the present invention, the printed board of the first housing and the printed board of the second housing act as an antenna by way of the plate member. In other words, a total length that is a combination of a longitudinal dimension of the first housing and a longitudinal dimension of the second housing can be used as an antenna. Therefore, a highly sensitive antenna can be obtained. In addition, the number of components can be curtailed when compared with a case where an antenna exhibiting equivalent performance, such as a whip antenna, is additionally provided. Moreover, as a result of the conductive portion of the hinge being used, in place of the power feed line, for the power feed path, a process for routing the power feed line into the hinge becomes obviated, and the number of assembly processes can be reduced. Further, in a portable radio having a power feed line, antenna performance is deteriorated as a result of the power feed line becoming deformed. However, the portable radio of the present invention can, in principle, prevent occurrence of deterioration of antenna performance. Hence, high antenna performance can stably be assured.

The present invention includes: a waterproof housing; a planar antenna placed outside the housing; a connector that is elastically connected to a conductive part of a printed board housed in the housing and that is elastically connected to the antenna; and a waterproof member that comes into close contact with the antenna and that surrounds a connection area between the antenna and the connector, to thus render the connection area waterproof.

In the portable terminal of the present invention, the planar antenna is placed outside the waterproof housing regardless of the type of the portable terminal; for instance, a foldable type and a straight type. The connector is elastically connected to the conductive part of the printed board housed in the housing, and the connector is elastically connected to the antenna.

The waterproof member is brought into close contact with the antenna, and the waterproof member surrounds the connection area between the antenna and the connector, thereby providing waterproof.

The connection area between the antenna and the connector is thereby made reliably waterproof.

The portable terminal of the present invention includes: a communication aperture through which the connector is exposed outside the housing; and a covering member that covers a connection area of the antenna to be connected to the connector, and is configured in that engagement of the covering member with an opening edge is maintained as a result of engagement claws provided on the covering member being engaged with the opening edge of the communication aperture and a portion of a support member supporting the connector being placed adjacently to the engagement claws.

There is provided a covering member that covers the communication aperture through which the connector is made exposed outside of the housing, and the covering member covers the connection area of the antenna to be connected to the connector of the antenna.

The covering member is provided with engagement claws, and a portion of the support member is placed adjacently with the engagement claws.

The engagement claws are thereby engaged with the opening edge of the communication aperture, and the portion of the support member supports the connector. Thus, engagement of the engagement claws with the opening edge is maintained, so that waterproof can be maintained.

### Advantageous Effects of Invention

The foldable portable terminal and the portable terminal of the present invention exhibit an advantage of reliable waterproof being achieved.

### BRIEF DESCRIPTION OF THE DRAWINGS

In FIG. 1, (A) is a perspective view showing that a foldable portable terminal of a first embodiment of the present invention is unfolded, and (B) is a perspective view showing that the foldable portable terminal of the first embodiment is folded.

FIG. 2 is an exploded perspective view showing an upper housing of the first embodiment when viewed from a display thereof.

FIG. 3 is an exploded perspective view showing the upper housing of the first embodiment when viewed from a front cover thereof.

FIG. 4 is an exploded perspective view showing a back cover making up the upper housing of the first embodiment when viewed from a board side.

FIG. 5 is a perspective view showing the back cover making up the upper housing of the first embodiment when viewed from the display side.

FIG. 6 is an enlarged view of block A shown in FIG. 2.

FIG. 7 is an enlarged view of block B shown in FIG. 4.

FIG. 8 is an exploded perspective view of the back cover of the first embodiment from which a plate member has been removed when viewed from a hinge case side.

FIG. 9 is an exploded perspective view of the back cover of the first embodiment from which the plate member has_been removed when viewed from a position opposite to the hinge case.

FIG. 10 is an enlarged view of block C shown in FIG. 9.

In FIG. 11, (A) is a front view showing a plate member and a waterproof member of the first embodiment, (B) is its side view, and (C) is its rear view.

FIG. 12 is a plan view showing the plate member and a housing recess of the first embodiment.

FIG. 13 is a rear view showing the plate member and the housing recess of the first embodiment.

In FIG. 14, (A) is a cross sectional view taken along line D-D shown in FIG. 4, and (B) is a cross sectional view taken along line E-E shown in FIG. 4.

FIG. 15 is an exploded perspective view showing a lower housing of a second embodiment when viewed from its rear surface.

FIG. 16 is an exploded perspective view showing the lower housing of the second embodiment when viewed from its front surface.

FIG. 17 is a perspective view showing a connector and a support member of the second embodiment.

FIG. 18 is a plan view showing the connector and an antenna of the second embodiment.

FIG. 19 is a perspective view showing a covering member and a first waterproof member of the second embodiment.

FIG. 20 is a plan view showing that the antenna is attached to the lower housing of the second embodiment.

FIG. 21 is a cross sectional view taken along line F-F shown in FIG. 20.

FIG. 22 is a cross sectional view taken along line G-G shown in FIG. 20.

### DESCRIPTION OF REFERENCE NUMERALS AND SYMBOLS

10, 70 Foldable portable terminal
11 Lower housing (Second housing)
14 Upper housing (First housing)
15 Display
17 Joint part
21 Lower printed board (Printed board)
21a, 28a Conductive part
23a Hinge-side end
28 Upper printed board (Printed board)
31 Hinge case
32 Hinge
41 First connector
42 Plate member
44 Second connector
45 Waterproof member
53 First protuberance (Portion of plate member (i.e., Protuberance))
57 First contact part (Other end)
58 Second contact part
72 Antenna
74 Connector
74a Connection area
76 Waterproof member
78 Covering member
81 Communication aperture
81a Opening edge
87 Support member
87a Protuberance (Portion of support member)
95 Engagement claw

### BEST MODES FOR IMPLEMENTING INVENTION

A foldable portable terminal and a portable terminal of embodiments of the present invention are hereunder described with reference to the drawings.

As shown in FIG. 1, a foldable portable terminal 10 of a first embodiment includes a lower housing (a second housing) 11 equipped with an operation part 12; an upper housing (a first housing) 14 equipped with a display 15; and a non-waterproof joint part 17 that joins the lower housing 11 to the upper housing 14 in a foldable manner.

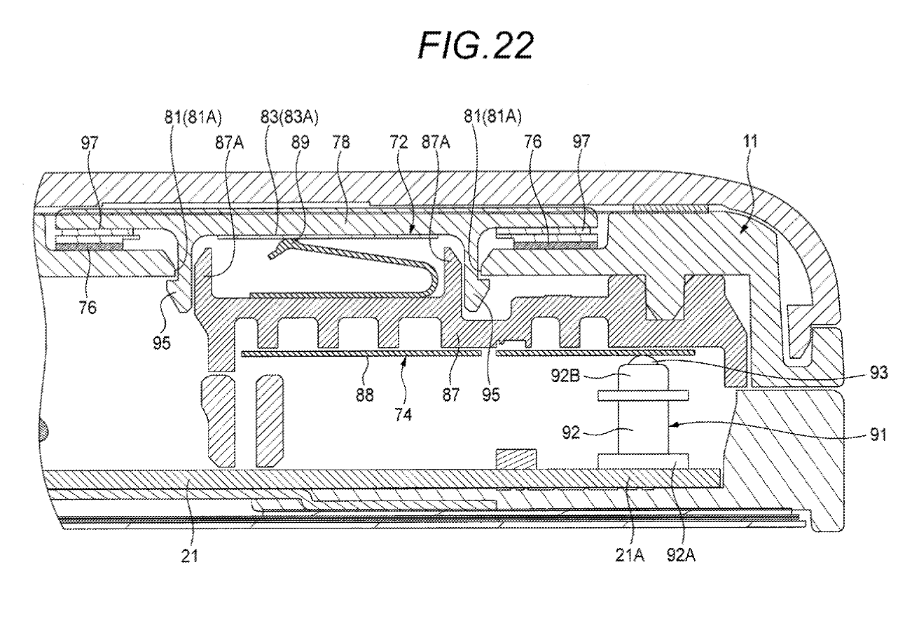

A lower printed board (a printed board) 21 (see FIG. 22) is provided in the lower housing 11, and the lower housing 11 exhibits a waterproof characteristic.

The upper housing 14 has a substantially rectangular front cover 23 formed in the shape of a boat; a rear cover 24 fitted to an open side of the front cover 23; and a decorative panel 25 covering the rear cover 24. The upper housing 14 also exhibits a waterproof characteristic.

A mount area 27 where a second connector 44 to be described later is placed is provided on a hinge-side end 23A of the front cover 23 in a longitudinal direction of the upper housing 14.

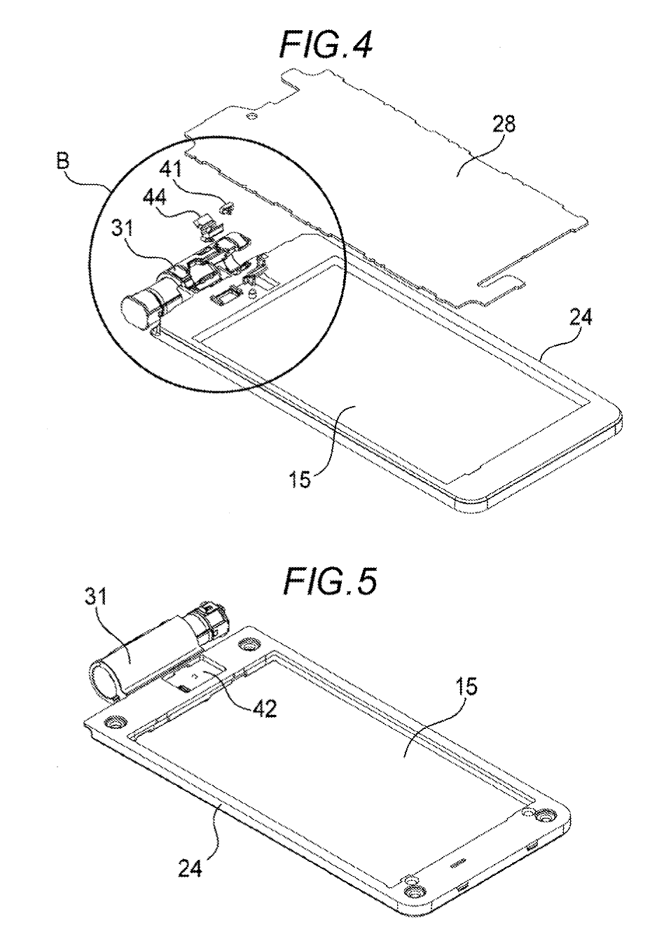

The rear cover 24 is formed into a substantially rectangular shape and has the display 15 and an upper printed board (a printed board) 28 (see FIG. 4).

In the rear cover 24, a non-waterproof hinge case 31 is provided on a hinge-side end 24A in a longitudinal direction of the upper housing 14. A housing recess 34 is provided on the hinge-side end 24A. A projecting aperture 35 is provided at a substantially center position of the housing recess 34. An insert aperture 37 is formed in a wall 34A of the housing recess 34.

A hinge 32 (see (A) in FIG. 14) exhibiting conductivity is provided in the hinge case 31.

As shown by (A) in FIG. 14, the joint part 17 is constituted by the hinge 32 and the hinge case 31.

The foldable portable terminal 10 has a first connector 41 provided in the hinge-side end 23A in the longitudinal direction of the upper housing 14;

a plate member 42 that is connected to the first connector 41 and that exhibits conductivity; a second connector 44 connected to both the plate member 42 and the hinge 32; a waterproof member 45 that makes the upper housing 14 waterproof with respect to the hinge case 31; a receiving material 47 that receives the plate member 42; and a housing dipole antenna that operates as an antenna.

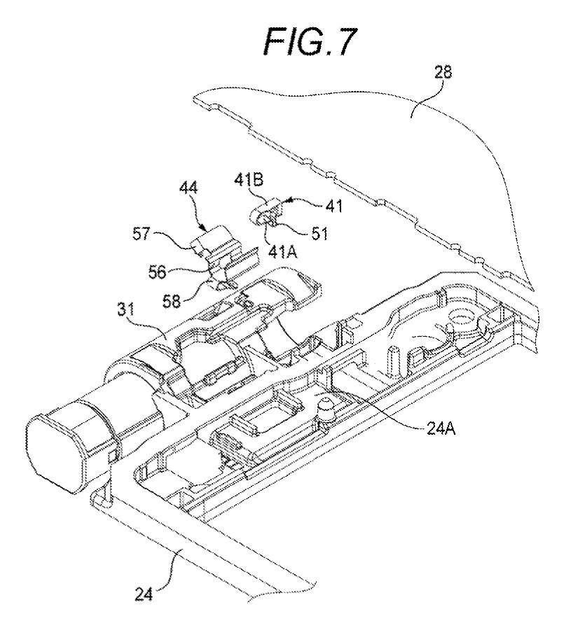

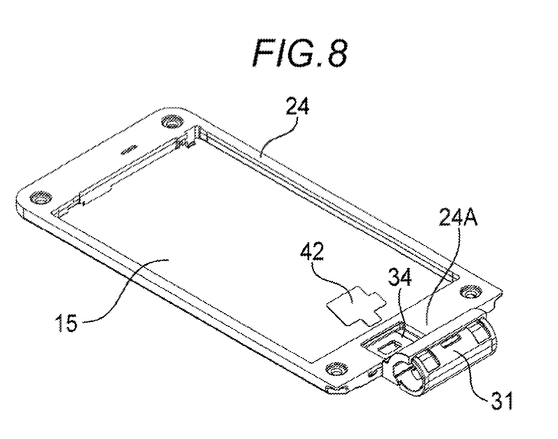

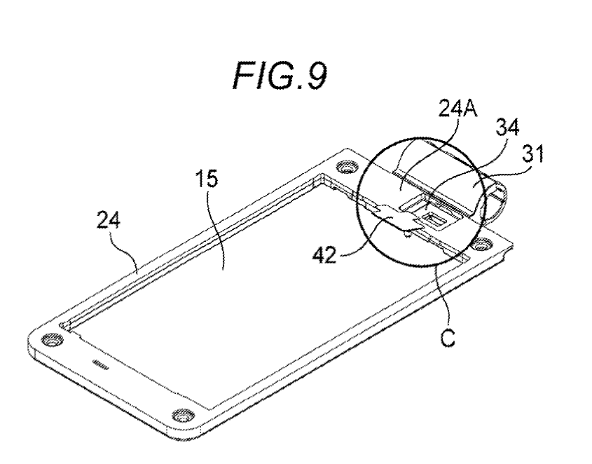

As shown in FIGS. 7 and 14, the first connector 41 is a leaf spring that is formed to be elastically deformable and assume a substantially U-shaped shape and that has a protuberance 51 formed at a lower end 41A of the first connector.

As a result of the first connector 41 being formed in the shape of a leaf spring, a connector can be realized in a simple structure.

In the first connector 41, an upper end 41B is connected (mounted) to the conductive part 28A of the upper printed board 28, and the protuberance 51 is elastically connected to the plate member 42.

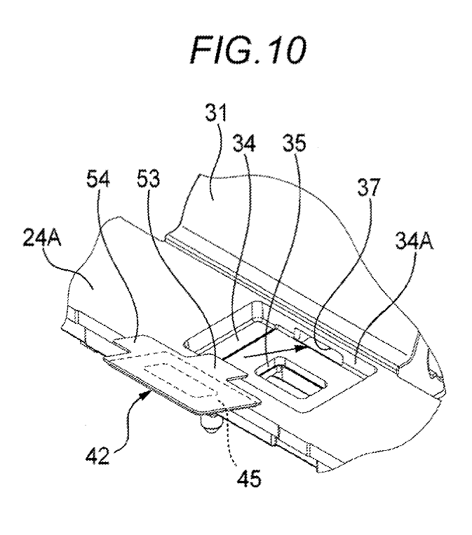

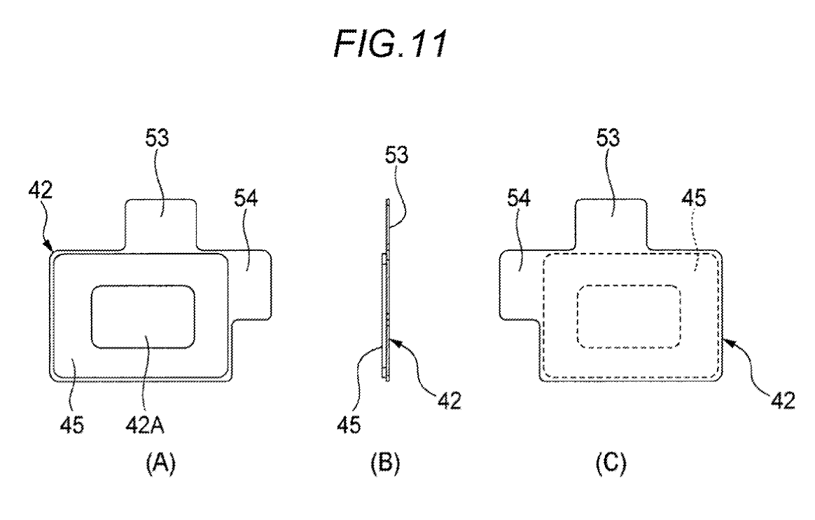

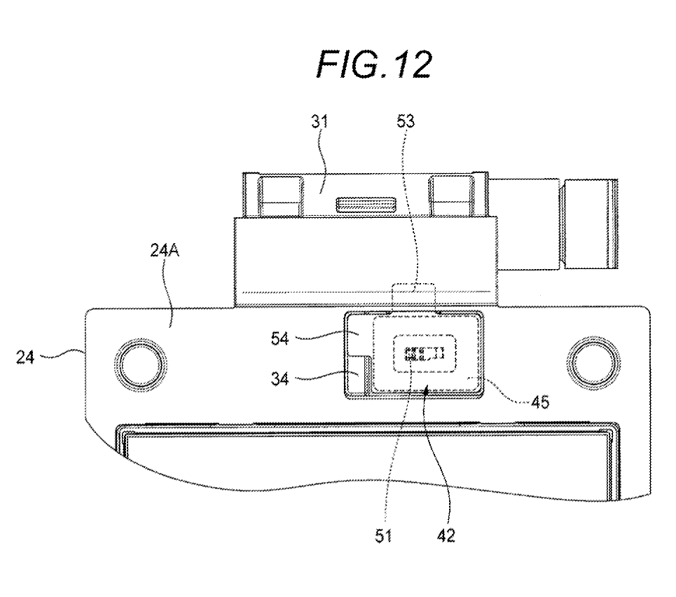

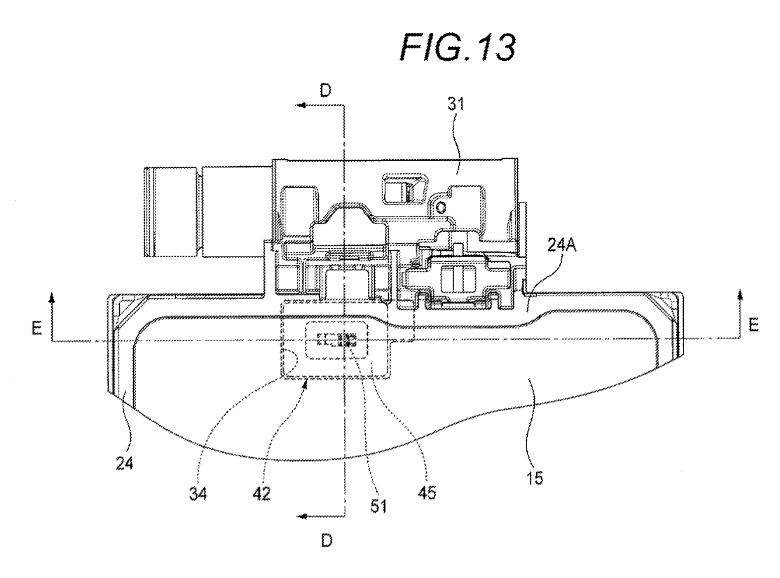

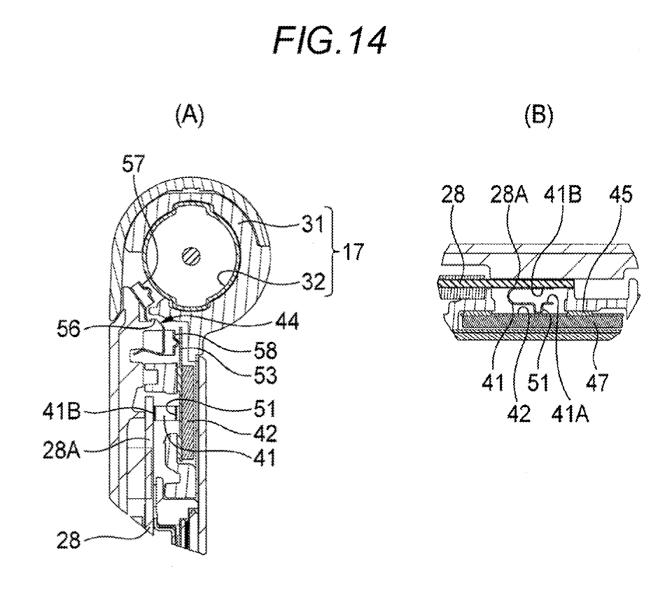

As shown in FIGS. 10 through 12, the plate member 42 is a metallic plate that is formed into a substantially rectangular shape and that has a first protuberance 53 and a second protuberance 54.

As a result of the plate member 42 being formed into a metallic plate, conductivity can be readily imparted to the plate member 42.

The plate member 42 is placed in the housing recess 34, and the first protuberance 53 (a portion of the plate member 42 (i.e., a protuberance)) is inserted into the insert aperture 37.

As a result of the plate member 42 being placed in the housing recess 34, the plate member 42 is interposed between the display 15 and the hinge 32 (see (A) in FIG. 14).

The plate member 24 is interposed between the display 15 and the hinge 32, and the first protuberance 53 is caused to project into the hinge 32. Hence, the length of the upper housing 14 in its longitudinal direction can be shortened while an antenna path length of the housing dipole antenna is assured. An attempt can thereby be made to miniaturize the foldable portable terminal 10.

As a result of the first protuberance 53 being inserted into the insert aperture 37, the first protuberance 53 (i.e., a portion of the plate member 42) is placed in (inserted into) the hinge case 31.

The second protuberance 54 is provided to facilitate operation for incorporating the plate member 42 into the housing recess 34.

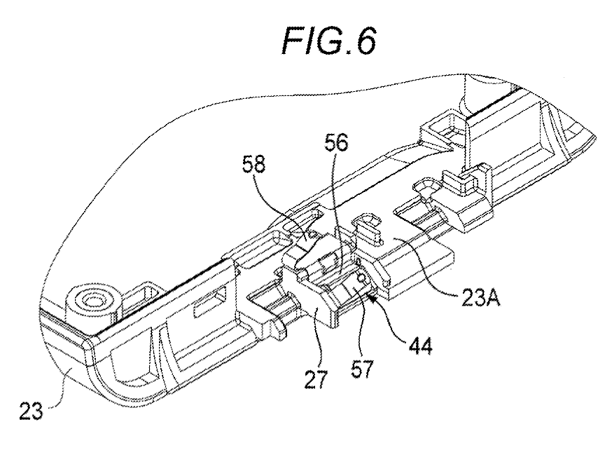

As shown in FIG. 6, the second connector 44 is a leaf spring that is placed at the mount area 27 of the front cover 23.

As a result of the second connector 44 being realized in the form of a leaf spring, a connector can be realized in a simple structure.

As shown in FIGS. 6 and 7, the second connector 44 has a latch 56 that can be latched onto the mount area 27; a first contact part (another end) 57 that protrudes out of the latch 56 and that is bent to be elastically deformable toward the hinge 32; and a second contact part 58 that protrudes out of the latch 56 and that is bent to be elastically deformable toward the plate member 42.

As shown by (A) in FIG. 14, the first contact part 57 is an area elastically connected to the hinge 32.

The second contact part 58 is an area elastically connected to the first protuberance 53 in the hinge case 31.

Since the first contact part 57 is connected to the hinge 32, and the second contact part 58 is connected to the first protuberance 53, power can be fed.

As show in FIGS. 10 and 11, the waterproof member 45 is a double-sided adhesive tape that closely contacts the plate member 42 and that makes the hinge case 31 waterproof with respect to the upper housing 14.

The waterproof member 45 is formed into a substantially rectangular frame and bonded to at least an area 42A of the plate member 42 that surrounds a contact point to be brought. into contact with the first connector 41.

Since the double-sided adhesive tape is used as the waterproof member 45, the area 42A surrounding the contact point that is to contact the first connector 41 can be made waterproof at low cost, and an attempt can be made to render assembly of the terminal easy.

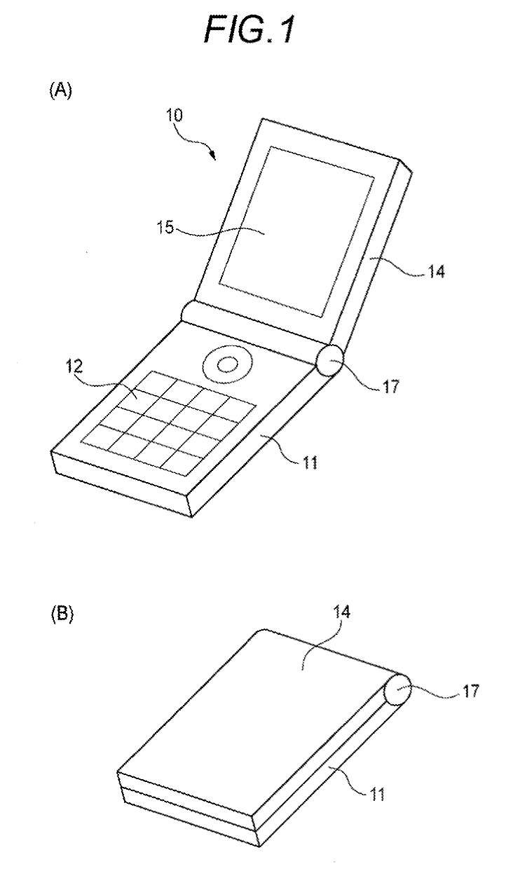

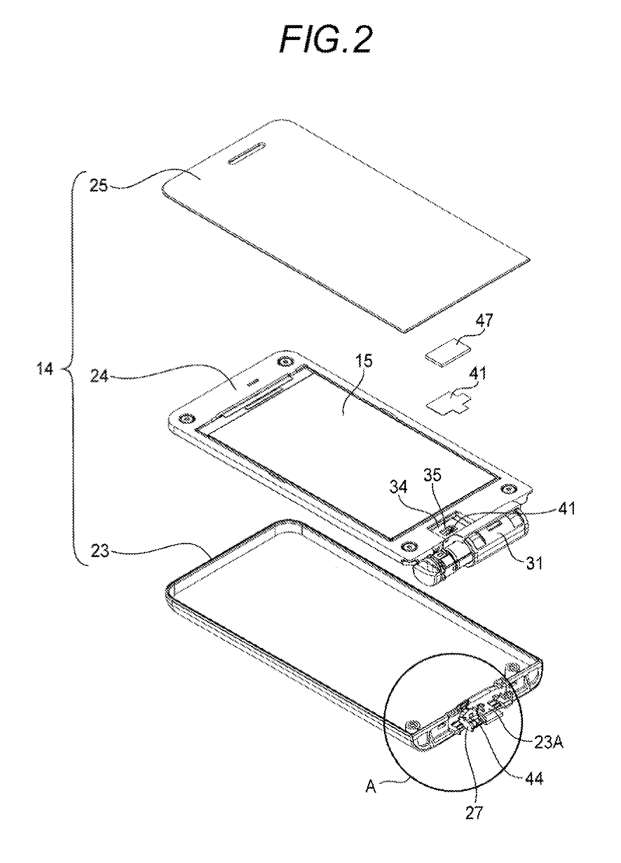

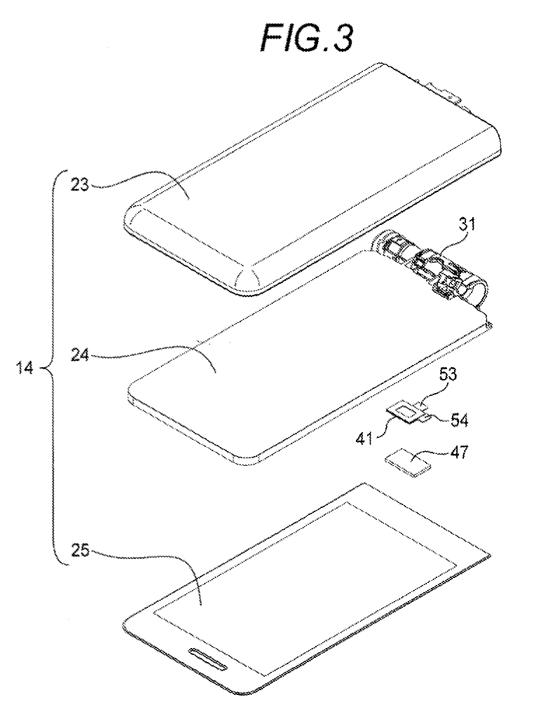

As shown in FIGS. 2 and 3, and (B) in FIG. 14, the receiving material 47 is formed into a substantially rectangular shape; receives the plate member 42; and exhibits a cushioning characteristic (elasticity) for appropriately pressing the plate member 42.

The housing dipole antenna is made up of a conductive part 28A of the upper printed board 28 provided in the upper housing 14, the plate member 42, the hinge 32, and a conductive part 21A of the lower printed board 21 placed in the lower housing 11 (see FIG. 22).

As mentioned above, in the foldable portable terminal 10 of the first embodiment, the waterproof member 45 is brought into close contact with the plate member 42, thereby making the hinge case 31 waterproof with respect to the upper housing 14.

Even when the housing dipole antenna is configured, reliable waterproof is thereby obtained.

### (Modification)

The foldable portable terminal 10 of the first embodiment has been described by reference to the example in which the metallic plate is used as the plate member 42. However, the plate member is not limited to the metallic plate, and the plate member 42 can also be embodied by a flexible board.

As a result of a flexible board being used as the plate member 42, there is yielded an advantage of the ability to enhance a degree of design flexibility.

### Second Embodiment

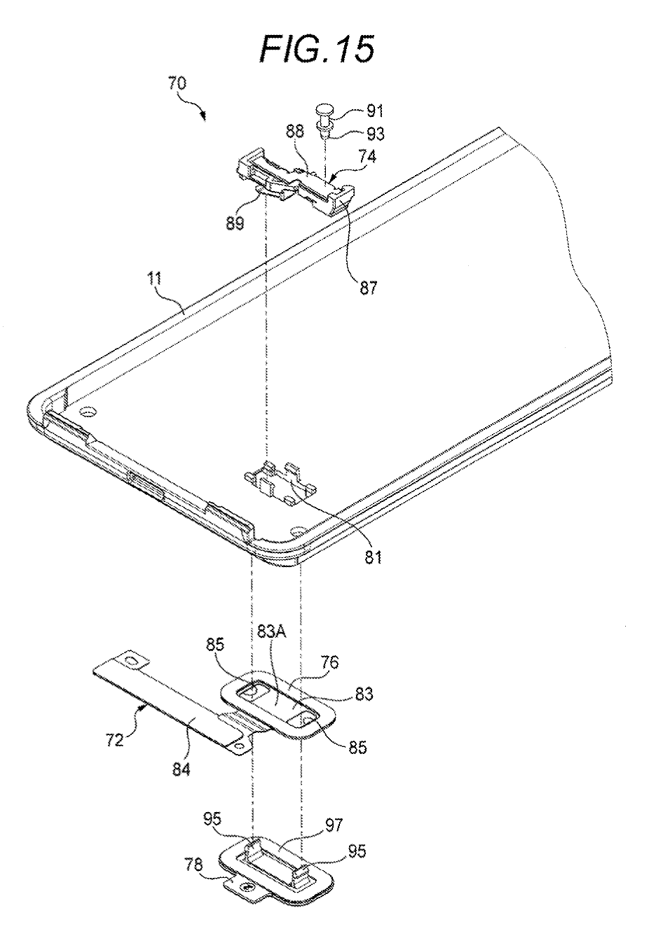

A second embodiment is now described by reference to FIGS. 15 through 22. In the second embodiment, members that are identical with or analogous to their counterparts of the first embodiment are assigned the same reference numerals, and their explanations are omitted.

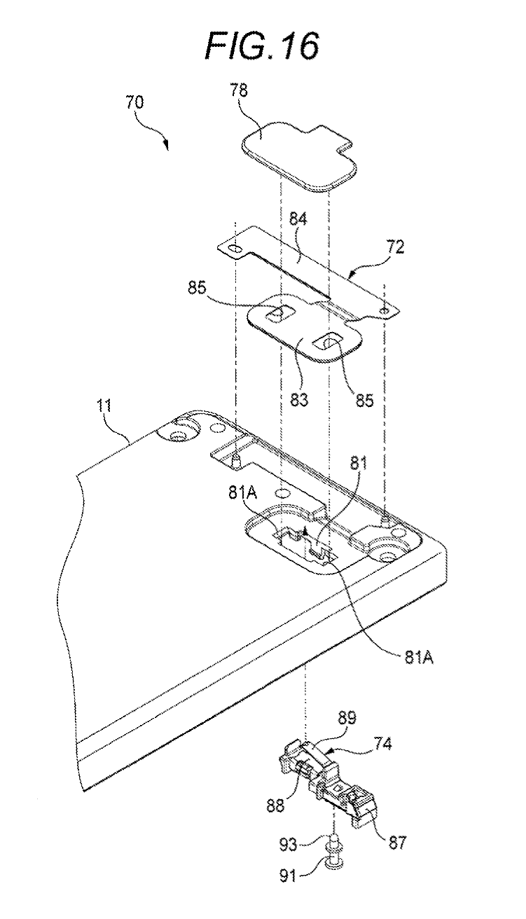

As shown in FIGS. 15 and 16, a foldable portable terminal 70 of the second embodiment has a planar antenna 72 placed outside the lower housing 11; a connector 74 elastically connected to the conductive part 21A of the lower printed board 21 (see FIG. 22) and the antenna 72; a first waterproof member (a waterproof member) 76 that surrounds the antenna 72 and a connection part 74A of the connector 74, thereby rendering them waterproof; and a covering member 78 that covers the antenna 72.

Although the second embodiment exemplifies the foldable portable terminal, the configuration described in connection with the second embodiment is also applicable to; for instance, a straight-type portable terminal.

The lower housing 11 has a communication aperture 81 that makes an antenna contact part 89 of the connector 74 exposed outside the lower housing 11.

The antenna 72 has a base 83 formed into a substantially rectangular shape and an antenna main body 84 extending from the base 83 like a belt.

A pair of through apertures 85 are formed at predetermined intervals in the base 83.

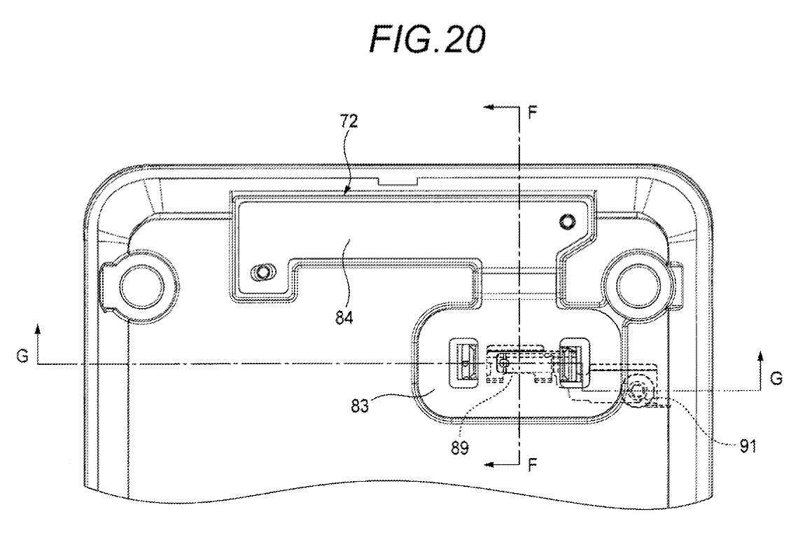

The antenna 72 is attached to the lower housing 11 as shown in FIG. 20.

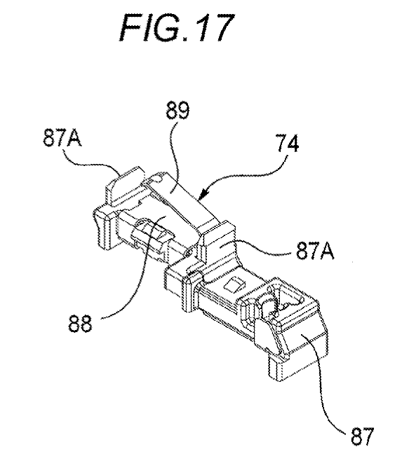

As shown in FIG. 17, the connector 74 is a member formed by bending a leaf spring.

The connector 74 has a main body 88 attached to a support member 87 made of a resin and an antenna contact part 89 that protrudes out of the main body 88 and that is bent toward the base 83 of the antenna 72 (see FIG. 16) in an elastically deformable fashion.

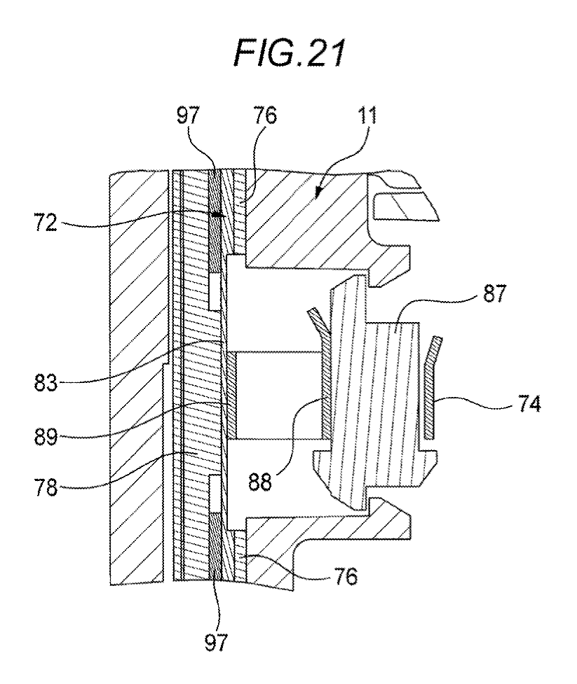

As shown in FIGS. 21 and 22, in the connector 74, the main body 88 is elastically connected to the conductive part 21A of the lower printed board 21 housed in the lower housing 11 by way of a pin connector 91 (see also FIG. 20), and the antenna contact part 89 is elastically connected to the base 83 of the antenna 72.

As shown in FIG. 22, in the pin connector 91, a base end 92A of a main body 92 is mounted to the conductive part 21A of the lower printed board 21, and a protuberance 93 is provided at a leading end 92B of the main body 92 so as to be able to protrude and recede by means of a coil spring (not shown).

The pin connector 91 is connected while the protuberance 93 remains pressed by the main body 88 of the connector 74.

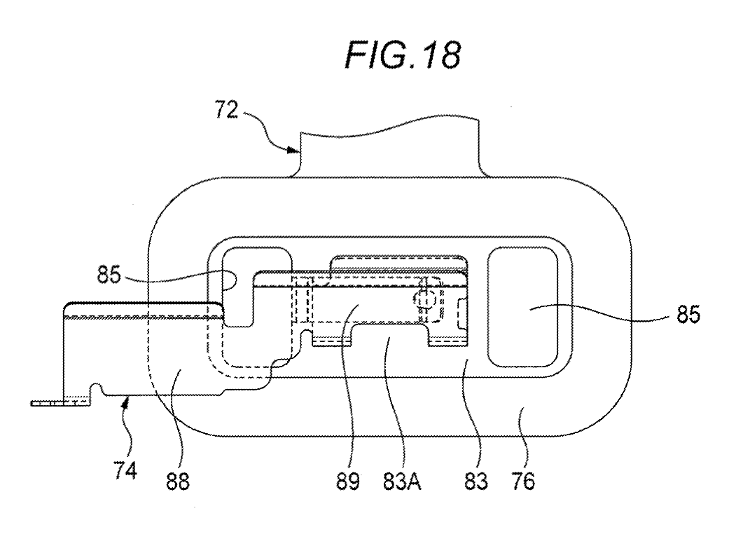

As shown in FIGS. 15 and 18, the first waterproof member 76 is a double-sided adhesive tape that is formed into a substantially rectangular frame and that is brought into close contact with an edge of the base 83 of the antenna 72 and surrounds a connection area 83A between the base 83 and the antenna contact part 89 of the connector 74, thereby rendering the connection area waterproof.

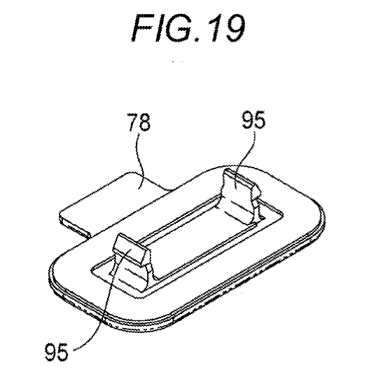

As shown in FIGS. 15 and 19, the covering member 78 is provided with a pair of engagement claws 95 that can engage with an opening edge 81A of the communication aperture 81 (see also FIG. 22).

The covering member 78 is formed into a substantially rectangular shape so as to cover the connection area 83A of the antenna 72 to be connected with the connector 74, and a pair of engagement claws 95 are provided at neighborhoods of both mutually-opposing sides.

As shown in FIG. 22, the pair of engagement claws 95 are members that can engage with the opening edge 81A of the communication aperture 81.

A portion of the support member 87 that supports the connector 74; specifically, a pair of protuberances 87A (see FIGS. 17 and 22), are placed to be adjacent to rear surfaces of the pair of engagement claws 95.

Therefore, engagement of the pair of engagement claws 95 with the opening edge 81A can be held by means of the pair of protuberances 87A.

Removal of the covering member is prevented by maintaining engagement of the pair of engagement claws 95 with the opening edge 81A of the communication aperture 81, thereby maintaining waterproof.

The covering member 78 is provided with a second waterproof member 97.

As shown in FIGS. 15 and 19, the second waterproof member 97 is a double-sided adhesive tape that is formed into the shape of a substantially rectangular frame and that is brought into close contact with an edge of the covering member 78 and surrounds the connection area 83A between the base 83 and the antenna contact part 89 of the connector 74, thereby rendering the connection area waterproof.

As mentioned above, in the foldable portable terminal 70 of the second embodiment, the first waterproof member 76 and the second waterproof member 97 are brought into close contact with the antenna 72, and the connection area 83A between the antenna 72 and the connector 74 is surrounded by the first waterproof member 76 and the second waterproof member 97, thereby making it possible to render the connection area waterproof.

The connection area 83A between the antenna 72 and the connector 74 can thereby be made reliably waterproof.

The first and second embodiments have provided explanations on the case where the double-sided adhesive tape is used as the waterproof member 45, the first waterproof member 76, and the second waterproof member 97. The waterproof members are not limited to the double-sided adhesive tape. Consequently, another waterproof member, such as packing, thermal compression, and an adhesive bond, can also be used.

The first and second embodiments have provided the example in which the metallic plate is used as the plate member 42. However, the plate member is not limited to the metallic plate. A member, such as a plated plastic plate, can also be used.

Moreover, in the first and second embodiments, the conductive part 28A of the upper printed board 28 and the conductive part 21A of the lower printed board 21 are utilized as the constituent members of the antenna.

However, the constituent members are not limited to the conductive parts. Another conductive member, such as a metallic frame of the lower housing 11 and a metallic frame of the upper housing 14, can also be used as the constituent members of the antenna.

The present patent application is based on Japanese Patent Application (No. 2008-162274) filed on Jun. 20, 2008, the entire subject matter of which is incorporated herein by reference.

### INDUSTRIAL APPLICABILITY

The present invention is preferably applicable to a foldable portable terminal and a portable terminal in which a first housing having a display and a second housing having an operation part are joined in a foldable manner by means of a joint part.

1. A foldable portable terminal, comprising:
a waterproof first housing;
a second housing; and
a non-waterproof joint part that joins the first housing to the second housing, wherein
the joint part has a conductive hinge and a non-waterproof hinge case which covers the hinge, and
the first housing comprises:
a first connector which is provided on a hinge-side end of the first housing in its longitudinal direction and which is connected to a conductive part of a printed board;
a plate conductive member which is connected to the first connector and a part of which is placed in the hinge case;
a second connector which is elastically connected to the plate member in the hinge case and which is connected at its another end to the hinge to feed electric power; and
a waterproof member that comes into close contact with the plate member and that makes the hinge case waterproof with respect to the first housing, and wherein
the conductive part of the printed board of the first housing, the plate member, the hinge, and a conductive part of a printed board disposed inside the second housing operate as an antenna.

2. The foldable portable terminal according to claim 1, wherein a protuberance is formed in the plate member, and the protuberance is placed in the hinge case.

3. The foldable portable terminal according to claim 1, wherein the plate member is a metallic plate.

4. The foldable portable terminal according to claim 1, wherein the plate member is a flexible board.

5. The foldable portable terminal according to claim 1, wherein the first connector or the second connector is a leaf spring.

6. The foldable portable terminal according to claim 1, wherein the waterproof member is a double-sided adhesive tape and bonded to at least an area of the plate member that surrounds a contact point to be brought into contact with the first connector.

7. The foldable portable terminal according to claim 1, wherein the first housing has a display, and the plate member is interposed between the display and the hinge.

8. (canceled)

9. A portable terminal, comprising:
a waterproof housing;
a planar antenna placed outside the housing;
a connector that is elastically connected to a conductive part of a printed board housed in the housing and that is elastically connected to the antenna;
a waterproof member that comes into close contact with the antenna and that surrounds a connection area between the antenna and the connector, to thus render the connection area waterproof;
a communication aperture through which the connector is exposed outside the housing; and
a covering member that covers a connection area of the antenna to be connected to the connector, wherein engagement of the covering member with an opening edge is maintained as a result of engagement claws provided on the covering member being engaged with the opening edge of the communication aperture and a portion of a support member supporting the connector being placed adjacently to the engagement claws.

10. (canceled)
